(19) United States
(12) Patent Application Publication
(10) Pub. No.: US 2016/0292312 A1
(43) Pub. Date: Oct. 6, 2016

(54) Method and system for creating and distributing solar energy system design, sales and marketing data

(71) Applicants: Chinmoy Prosun Saha, San Ramon, CA (US); Jeffrey Scott Pickles, Sunnyvale, CA (US); Yuen Sheung Chan, San Ramon, CA (US)

(72) Inventors: Chinmoy Prosun Saha, San Ramon, CA (US); Jeffrey Scott Pickles, Sunnyvale, CA (US); Yuen Sheung Chan, San Ramon, CA (US)

(21) Appl. No.: 15/090,622

(22) Filed: Apr. 5, 2016

Related U.S. Application Data
(60) Provisional application No. 62/143,149, filed on Apr. 5, 2015.

(51) Int. Cl. G06F 17/50; G06Q 40/00; G06Q 50/06; G06Q 20/10

(52) U.S. Cl. CPC G06F 17/5004; G06Q 20/10; G06Q 40/00; G06Q 50/06

(57) ABSTRACT

The present invention solves a complex real problem that is a major obstacles for solar energy mass proliferation. Installation site survey is a very cost intensive business process for roof-top and ground mount solar energy systems it keeps the solar energy system cost relatively higher, This cost category is termed as ‘soft-cost’ in the industry. The present invention provides a method and system for conducting aerial data collection and producing specific geometric, geographic and solar shading related data of any physical locations using unmanned aircraft system (UAS)/unmanned aerial vehicle(UAV)/remotely operated aircraft (ROA)/remotely piloted aircraft system (RPAS) platforms. This dataset is required for solar energy systems design, sales and marketing business processes. A comprehensive solar system design report is automatically generated and visualized via communication network incorporated in this system for a single or multiple solar site(s). State-of-the-art solar shade measurement handheld tools are difficult to use and involves costly boots-on-the-sites manual site survey approach. This invention is a better and low-cost automated solution to this solar industry's state-of-the-art problem.

### RELATED APPLICATIONS

The present application claims priority to U.S. Provisional Patent Application Ser. No. 62/143,149, entitled, “ Method and system for creating and distributing solar energy system design, sales and marketing data,” filed Apr. 5, 2015, incorporated by reference herein in its entirety. The present application is related to the U.S. utility patent application Ser. No. 14/120,113, filed Apr. 24, 2014 entitled, “Solar potential identification number and crowd purchase of solar energy generator systems,” pending which is incorporated by reference herein in its entirety.

### BACKGROUND

The high customer acquisition cost and complexity of residential, commercial and utility scale solar installation site survey prevents its mass adoption in the U.S. and global markets. One of the key factors for the high cost is the labor associated with site survey, early stage project sales and marketing and origination. Several websites collect consumers' information and sell the potential customers' information (leads) to multiple solar installers. This information exchange among the consumer sales lead collectors and the installers are not coordinated effectively. As a result the consumers have to participate in tedious lengthy pre-sales engineering and financial analyses with each installer to obtain the multiple quotes on their system. Consumers are often overwhelmed with repetitive sales pitches and in-person manual pre-sales site assessments and this process increases the customer acquisition cost for all installers. The customer will ultimately only install the system once, yet multiple installers will perform the similar pre-sales site assessment at their cost. This over selling process cost a huge amount of financial waste for the whole industry. There are several organizations that have web-based calculators for solar decision making based on simple cost benefit analysis. The accuracy and effectiveness of these calculators are very low because of the over simplicity of their analysis. For instance, they process the solar cost benefit analysis results based on a property's zip code rather than exact street address and actual site survey for accurate building measurement, obstructions and surrounding structures and vegetations. Such an approach fails to take into consideration the factors that are specific to the property itself. Currently several solar installers use publicly available internet maps to perform the pre-sales site analysis to screen potential customers. This process requires that a sales associate be trained in solar and in the use of these software products to manually perform the pre-sales assessments. Even with the use of these aerial or satellite photos, it is not possible to accurately determine the design data such as roof dimensions, identify roof obstructions/penetrations and calculate the shade factors and tilt and azimuth for each roof plane within the level of accuracy needed to perform a detailed design and offer an accurate price quote. After completing the lengthy pre-sales process, installers use telephone sales calls, e-mails and site visits to review a wide range of purchase options, lease or power purchase agreement (PPA) and ultimately provide a system quote to a customer. Currently there is no simple process to generate solar design data by any end users (home owners, business owners, solar installers, government agencies and utilities). The solar system specifications and pricings from different installers in a region are dispersedly published on the individual installer's website or can be obtained by engaging sales team of the installer which is a tedious process for everyone in the solar ecosystem. The physical site assessment is done manually and repeatedly by each individual installer to varying degrees of accuracy. The knowledge of a typical sales person regarding system design parameters and pricing is inadequate which may discourage consumers to make solar generator system purchasing decision.

Another problem with the current state of solar system design engineering and sales processes is that it requires an installer or sales associate often must climb onto a rooftop to survey the area of system installation. This practice creates a risk of injury to the sales associate, wear and tear to the roof and sides of a building, and exposure of legal liability for the property owners and installers. In addition, this is a time consuming and costly method which requires the potential solar customers to meet the site evaluators in person for each interaction in design, sales and marketing process.

There are some prior arts of creating large area solar evaluation data remotely using manned aircraft based aerial survey. This large area survey using manned aircraft needs very high upfront cost for the solar companies. This manned aircraft survey may work cost effectively for regional, statewide and nationwide solar design data generation surveys. Due to the high upfront cost, manned aircraft survey is not practical for neighborhood or individual building/parcel level solar design data generation. In addition, manned aircraft survey is conducted at a higher flight altitude from 1000 feet to 10,000 feet depending upon the aircraft types and size of a survey area. This high altitude manned aircraft survey poses a challenge to capture detailed roof and associated features to generate solar design data with sufficient accuracy to eliminate onsite manual measurements. In general, manned aircraft are more energy intensive to operate per unit thrust and per unit area surveyed compare to small unmanned aircraft system (UAS). Unmanned aircraft is more energy efficient and they are mostly electrically propelled. The higher efficiency of electric propulsion provides an opportunity to reduce fossil fuel utilization in solar design data creation by using unmanned aircraft system for aerial site survey. Unmanned aircraft involves no risks to human lives during the survey process because they are remotely piloted by human on the ground as opposed to manned piloted aircraft.

Thus, there remains a heartfelt need for an improved system and method in which the solar design data generation process can be automated and used in sales and marketing of solar generator systems with lower upfront cost, at a lower environmental impact and at a reduced risk to human lives and properties.

### SUMMARY OF THE INVENTION

This invention uses special aerial imaging and remote sensing platform and tools on a connected computer system to qualify and quantify suitability of a single or multiple site(s) for rooftop and or ground mount residential/commercial/utility solar energy system in communication with the users. The aerial imaging platforms are unmanned aircraft system (UAS) also know as unmanned aerial vehicle (UAV) or remotely operated aircraft (ROA) or remotely piloted aircraft system (RPAS), commonly referred to as drone. The imaging systems on this platform cover both visible and invisible techniques including, digital camera and/or Light Detection and Ranging (LIDAR) and/or Infrared (IR) and or Hyper-spectral sensors and/or Multi-Spectral and/or Radio Detection and Ranging (RADAR) and/or Synthetic Aperture Radar (SAR) and/or Sound Navigation and Ranging (SONAR) and/or Photon Counter involving a synchronized work flow.

In one embodiment, a single target site or a group of geographically collocated sites can be aerially surveyed to produce and distribute solar design data automatically by this invention. This method involves producing classified point clouds in three dimensional (3D) spatial coordinates from geographically oriented images or data acquired from UAS and applying novel algorithms and available weather data for extracting features and calculating required solar parameters, roof linear dimensions, planer area, setback area, obstructions, tilt, azimuth, surface orientation factor (SOF) and shading in term o of daily, monthly and annual solar access (SA).

In another embodiment, this invention combines aerial imaging, geographic information systems (GIS), computer vision and processing, physics and financial calculations to produce scientific and economic parameters related to solar energy sites without a manual site survey and use of state-of-the-art handheld tools.

In another embodiment, this invention eliminates rigorous boots-on-the-sites approach in current solar site design process. This invention produces solar energy system design and marketing data for every site within a survey area automatically without manual measurements or climbing on the roof.

In another embodiment, this invention enables accessibility of solar design, sales and marketing data over the internet using computers with minimal human interactions.

Many other features and advantages of the present invention will be realized by those skilled in the art upon reading the following description, when considered in conjunction with the drawings, in which:

### BRIEF DESCRIPTION OF THE DRAWINGS

FIG. 1 illustrates a graphical overview of the system and method organized to implement embodiments of the present invention.

FIG. 2 illustrates a set of exemplary functional data acquisition equipment in a typical solar site to implement one of the embodiments of the present invention.

FIG. 3 illustrates a diagrammatic presentation of the sequential steps performed in the image data processing in accordance with the present invention.

FIG. 4 illustrates images of detailed sequential steps in combined image and LIDAR spatial data processing to implement one of the embodiments of the present invention.

FIG. 5 illustrates exemplary images of a detailed solar design analysis for shading in accordance with the present invention.

FIG. 6 illustrates images of a set of exemplary solar design, sales and marketing related data products produced in accordance with the present invention.

FIG. 7 illustrates a diagrammatic representation of the data processing and visualization interface to implement one of the embodiments of the present invention.

### DETAILED DESCRIPTION OF THE DRAWINGS

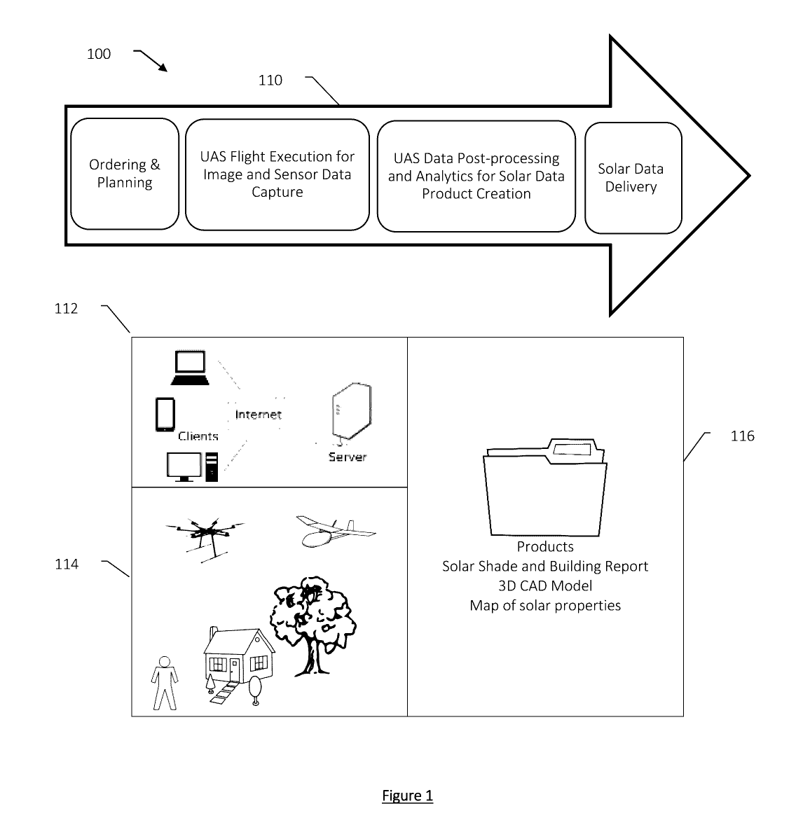

Directing attention to FIG. 1, there is shown the steps and functional components of the embodiments of the present invention 100. The work flow diagram, 110 illustrates the major sequential steps involved in the method of the present invention.

Communication network, 112 illustrates one embodiment of the present invention where the end users log into the connected system using a smart phone or tablet app or software of a PC with internet connection, selects the area to be surveyed, the desired products and the type of data that will be collected and places the work order which initiates a new UAS-based aerial solar sire survey. Network system, 112 is a system for communication which includes, for example, an Ethernet or other wire-based network, a wireless network interface such as WI-FI or one or more portions of the Internet or a combination of two or more of these. One or more portions of one or more of these networks may be wired or wireless. As another example, network, 112 can be a standard wireless 3G or 4G or similar network, a cellular telephone network such as, a global system for mobile communications (GSM).

In another embodiment, communication network, 112 uses standard communications technologies and/or protocols such as, transmission control protocol/ internet protocol (TCP/IP), hypertext transport protocol (HTTP), file transfer protocol (FTP), simple mail transfer protocol (SMTP), user datagram protocol (UDP), and multiprotocol label switching (MPLS). In one embodiment, the data exchanged over network, 112 may include, technologies and/or formats such as extensible markup language (XML) and hypertext markup language (HTML). Data can be encrypted using standard encryption technologies such as transport layer security (TLS), secure sockets layer (SSL) and internet protocol security (IPsec).

The end users pay for the order online to the system owner. In another embodiment, the end users collect desired imageries using their own UAS and upload the data to the network system, 112 or uses the desktop application to produce desired solar design and sales and marketing data using this invention. In this embodiment the payment may be made through a software subscription service. In the image acquisition process, 114 the user selects to either upload the data to the network system in near real time or to save the data for uploading at a later time and performs the solar site survey with the UAS. The site survey collects data of all the features including, buildings, roof details, trees, terrain, water, vehicles, vegetation and other structures. The UAS can be any type of aircraft, including multi-rotor or fixed wing. The collected data may include, infrared (IR) or visible range photos, LIDAR, SAR, RADAR, SONAR, photon counter, multi or hyper-spectral sensor data along with global positioning system (GPS) location, longitude, latitude, inertial measurement unit (IMU) parameters, tilt, yaw, pitch, roll, speed, altitude date and time which are associated with the data.

In another embodiment, the communication network, 112 is connected to the data processing computers. In this embodiment, the survey is completed and the data is uploaded to the computer over the communication network, 112. In another embodiment the survey data is stored locally on personal computer with this system. In both embodiments, the system runs a combination of calculations and data post processing operations using our proprietary algorithms and off-the-shelf software tools. The proprietary algorithms may be independent executable applications developed using standard computer language such as, Python, C++, IDL or JAVA which operate in standard operating system such as, Windows, Linux, Unix or MacOS. In another embodiment, the proprietary algorithms are developed as extension or plug-in of different off-the-shelf software applications using applicable software development kit (SDK) in conjunction with application program interface (API). The dataflow in this system is automated by transferring data between the proprietary algorithms and off-the-shelf applications. This data transaction can be accomplished using compatible spatial and non-spatial databases including, but not limiting, PostGIS, Oracle Spatial, SQL or VMDS and data files in standard formats without limitation to, such as, Shape file, KML, KMZ, CSV, TXT, LAS, LAZ, JPEG, TIF, RAW, DAE, PLY, OBJ or XLS extension.

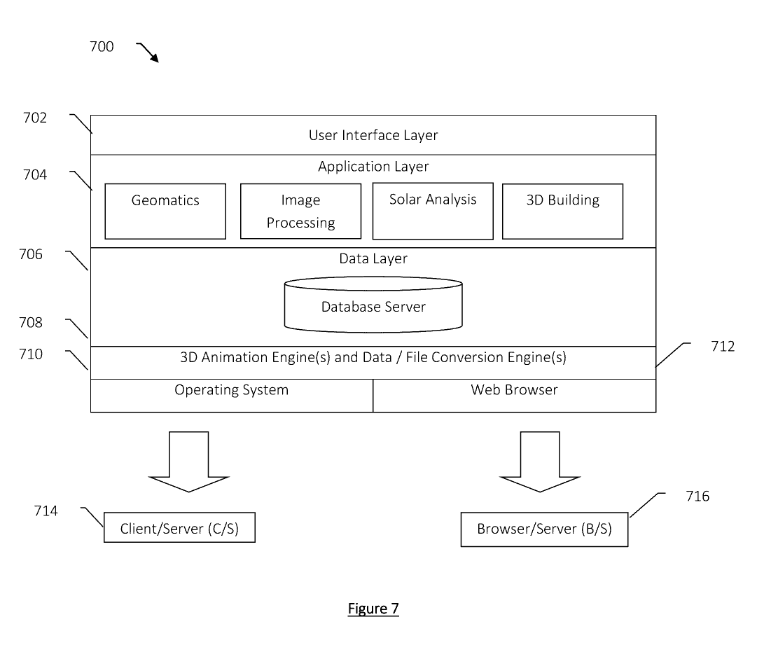

The system produces selected end data products, 116 including, solar design report containing 2D and 3D building/site model, detailed measurements, shade data, electrical generation data and financial data. In one embodiment the users using the communication network, 112 may view and download the solar data products. The data visualization system architecture is described in greater details in FIG. 7. In another embodiment, the users using the system in local computers may view and extract the automatically generated solar data products. In both embodiments, the users may select verity of data formats such as common GIS, image, video, CAD and document to download the data.

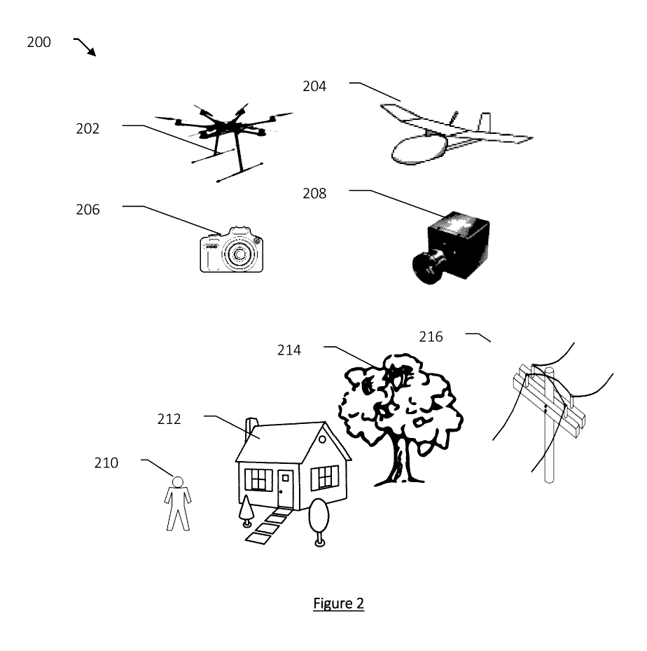

Directing attention to FIG. 2, there is shown generally a solar site data acquisition environment, 200 in which embodiments of the present invention operates. Using multi rotor, 202 or fixed wing, 204 UAS to collect data or images using visual imaging device, 206 and/or LIDAR/multi-spectral/hyper-spectral/infrared sensor, 208 by an operator, 210 with remote controlling device as needed to collect imageries of solar installation site, 212 including, vegetations 214 and surrounding structures 216 to produce the required solar design, sales and marketing data products, 116 including, buildings and terrain measurements, solar analysis data, shading parameters, 2D solar maps, 3D site models, shade animations and reports.

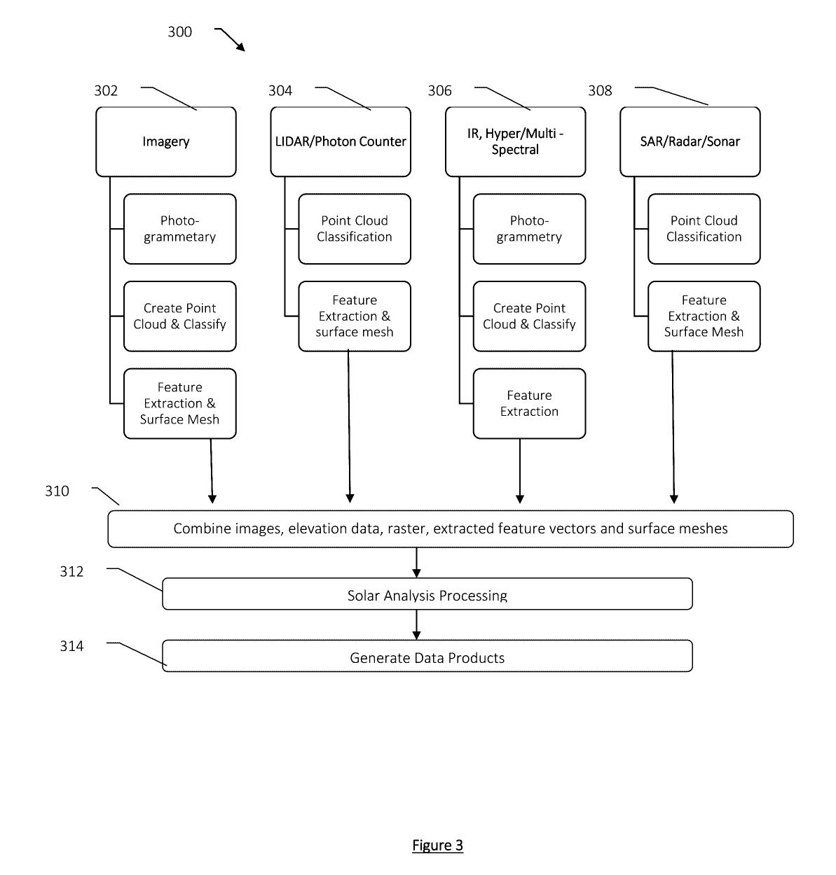

In one embodiment, the UAS uses a digital camera or infrared or multi-spectral or hyper-spectral sensors. Multiple georeferenced aerial images of a solar site are acquired with specific overlap to be used with photogrammetric tools and techniques to produce colorized high density point cloud and surface mesh of a solar site in process, 300 (refer to FIG. 3). In another embodiment, the UAS uses a LIDAR sensor and optional digital camera to acquire georeferenced raw LIDAR data and optional photograph to produce colorized point could and surface mesh of a solar site in process, 300 (refer to FIG. 3). The users may save the data in local computer storage and/or upload to the network system 112 (refer to FIG. 1) for onsite or remote processing using the system of this present invention.

Directing attention to FIG. 3, there is shown generally a flow diagram, 300 of solar site data processing in which one of the embodiments of the present invention operates. Imagery process, 302 has a work flow of photogrammetry, creating point cloud, classifying point cloud and extracting features and creating surface meshes of buildings, structures, trees and terrain for a given solar installation site. Its input is typically photographs taken using a digital camera in visual band and its output is 3D polygons, vectors, points and lines. LIDAR process, 304 has a workflow of classifying point cloud and extracting features and creating surface meshes of buildings, trees and terrain for a given solar installation site. Its input is typically LIDAR point data and its output is 3D polygons, vectors, points and lines. IR, hyper-spectral/multi-spectral process, 306 has a workflow of photogrammetry, creating point cloud, classifying point cloud and extracting features and creating surface meshes of buildings, trees and terrain for a given solar installation site. Its input is typically IR/hyper-spectral/multi-spectral images and its output is 3D polygons, vectors, points and lines. SAR/RADAR/ SONAR process, 308 has a workflow of creating point cloud, classifying point cloud and extracting features and creating surface mesh of buildings, trees and terrain for a given solar installation site. Its input is typically SAR/RADAR/ SONAR data and its output is 3D polygons, vectors, points and lines.

In this embodiment, the data processing, 302, 304, 306 or 308 can be used alone or in combinations to create combined images, rasters, extracted features, vectors and surface meshes, 310. This data is then used for solar design analysis process, 312. The results of this analysis, 314 is the data generated by this present invention which is distributed among the users using network communication system of this invention, 112.

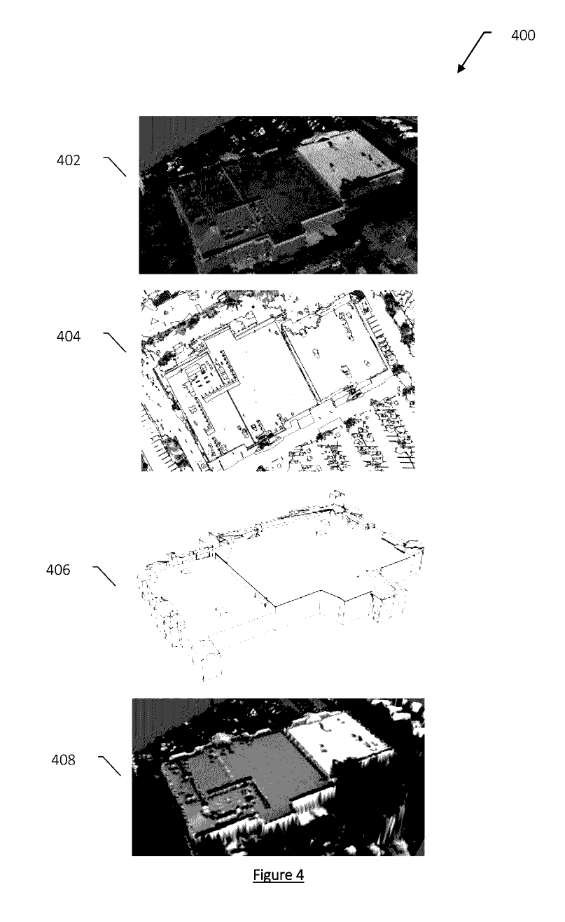

Directing attention to FIG. 4, there is shown example images, 400 of the detailed sequential steps in combined image and LIDAR spatial data processing to implement one of the embodiments of the present invention. The colorized images are used in 400 to explain and distinguish features by color and the data processing results. The color assignment is random. Classified point cloud, 402 is produced from photogrammetry or LIDAR data. Point cloud may be classified to standards such as defined by the American Society for Photogrammetry and Remote Sensing (ASPRS). Classified point cloud may contain building, vegetation, ground, water and unclassified points. Features are automatically defined from the classified point cloud using feature extraction algorithms. The extracted features generally include, the average roof plane and trees which do not typically capture the minute features such as, roof obstructions. One of the embodiments of this present invention is an iterative point cloud classification and feature extraction process to extract features of the roof obstructions. In this process a new class is assigned to certain points after initial feature extraction that were originally classified as buildings and are above a threshold height from an average roof plane. The average roof vectors are combined with the roof obstruction vectors to produce a complete roof vector file with obstructions for each roof as represented by 402.

In addition to LIDAR points processing, 402 additional image processing is performed on any combinations of visible, IR, multi-spectral or hyper-spectral images, 404. This image processing extracts 2D vectors which show the detailed roof obstructions. The features are defined based on the pixel values of wavelength and intensity using visible, infrared, multi-spectral or hyper-spectral images. The roof obstructions may include, skylight, chimney, vents, pipes, HVAC equipment, wind screens, facade or antenna. These 2D features are assigned elevation values from point cloud data 402 to produce detailed 3D roof obstructions. This roof obstructions are combined with the feature extracted from the point cloud to produce a complete 3D roof model including minute roof obstructions. 3D roof model is extruded down to the ground level to produce an example 3D building model, 406.

In another embodiment, a surface mesh or digital surface model (DSM) or triangulated irregular network (TIN) file which covers the buildings, trees and terrain of the point cloud is produced as shown in example 408. This surface meshes can be combined with average roof planes extracted from point cloud, 402 to produce detailed 3D building model similar to 406.

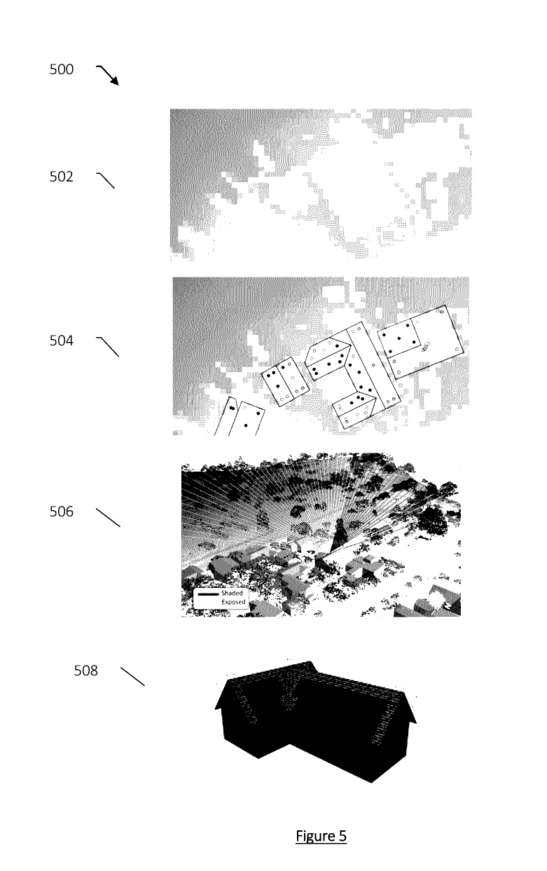

Directing attention to FIG. 5, there is shown example images, 500 of the solar data generation analysis. Inputs to the solar analysis of the present invention are the DSM, 502 of the site and the defined solar points, 504 shown with the average roof plane for clarity. In this method solar analysis is performed on specific locations (solar points) of the site. Solar points are defined by specific rules for roof top or ground mounted solar energy system. An example rule for a roof top site is to define the setback areas on the extracted roof planes and define solar points on the vertices and center of the setbacks as shown in 504. Similar rule can be applied for ground mount solar site using property lines, slopes, building proximities and other installations. An example setback algorithm visualized in 508 has a work flow of creating new setbacks, for example, from fire codes. Its input are polygons generated in process, 400 and an external set of variables, such as a fire code. Its output is new 3D polygons. It is important to define the roof setbacks according to the fire code to define the allowable area to install solar panels. The center and vertices of these areas should be used to measure the shade factors. According to the Solar Photovoltaic Installation Guideline released by the California Department of Forestry and Fire Protection, there should be some space between the panels and the roof edges depending on the roof layout.

For residential buildings with hip roof layouts, modules (solar panels) should be located in a manner that provides one three-foot wide clear access pathway from the eave to the ridge on each roof slope where modules are located. For residential buildings with a single ridge, modules should be located in a manner that provides two three-foot wide access pathways from the eave to the ridge on each roof slope where modules are located. For hips and valleys, modules should be located no closer than one and one half (1.5) feet to a hip or a valley if modules are to be placed on both sides of a hip or valley. If the modules are to be located on only one side of a hip or valley that is of equal length then the modules may be placed directly adjacent to the hip or valley. Modules should be located no higher than three feet below the ridge.

The present invention automatically classifies the roof edges into different categories such as eave, ridge, valley, hip, and gable edges in order to determine how the solar panels should be placed on the roofs. To classify the edges, we first convert the building shape file into polygons made of lines. A line is classified as ridge if (i) the angle between the line and the horizon is less than a threshold, and (ii) the line is common between two polygons. If condition (i) is satisfied but condition (ii) is not satisfied, then the line is classified as eave. If condition (i) is not satisfied but condition (ii) is satisfied, then the line is classified as hip or valley depending on the outer angle between the two intersecting planes. All other lines are classified as gable edges. The roof layout may also be determined by the type of lines in the building shape file. The roof setback may be applied depending on the roof layout. First the whole roof is selected as the potential area for placing the solar panels. Then the selected area is contracted from all edges except the eaves using “erosion” operation. Then the area is covered by the panels using another algorithm that takes into account the panel size and the roof area. The output of the setback calculations produces a 3D polygons.

In one embodiment of this invention, solar analysis is performed using a solar viewshed algorithm which is visualized as 506 which has a work flow of performing a solar viewshed on collection of solar points for a time interval which can range from 1 second to 60 minutes, intervals, typically on a daily basis. Its inputs are the DSM and solar points and its outputs are attributes of shaded and sun durations for each solar points. In another embodiment of this invention, the solar analysis is performed using only the point cloud as inputs. Both embodiments of the present invention may utilize graphics processing unit (GPU) rather than central processing units (CPUs) of a computer to quickly determine shade factors for a large number of points. Solar viewshed evaluates the duration of shaded time for each point of interest. Results of the solar analysis are mathematically weighted with the meteorological data to produce the solar access for each point.

Weighting of sun duration with weather data is now described as performed in one of the embodiments of the present invention. After the sun duration for each solar access point is completed for a time interval (15 minutes typical) for the year then the local weather data direct normal insolation in kWh/m² or global radiation in kWh/m² is used to account for the solar access for each point for each month and annual average.

The sun duration for each access point is calculated using the sun position, digital surface models, point cloud and building polygons as inputs using a combination of CPU and GPU processing including ray tracing and solar viewshed algorithms.

The sun duration is a value of 0 to 0.25 hours (using 15 minute intervals) for the duration of sun time. Each solar access point is assigned multiple duration values starting with TO for the first interval of sun light in the day ending with Tn for the last interval of sun time in the day. The starting and ending times can be the sun rise and sun set as defined by the sun position and the skyline captured by point cloud or digital surface models, or the starting and ending times can be chosen by user as windowed shading starting and ending at specific clock times.

The sun duration values are summed to match the temporal resolution of the weather data. For an example, if the sun duration of 15 minutes is used with hourly weather data, then every 4 sun duration values are summed to produce hourly sun duration values.

Then each interval of sun duration and direct normal insolation from the weather file are multiplied. The sun duration is a value of 0 to 1 for each interval therefore resulting in a maximum insolation of the value in the weather data and a minimum value of 0. Then all the intervals for each day are summed and the total is divided by the total direct normal insolation of that day from the weather file resulting in a solar access value of 0 to 1 for that day. Then the monthly and annual average solar access are calculated from the daily values.

What follows is an exemplary solar access calculation for a given day using 15-minute sun time durations with hourly typical meteorological year 3 (TMY3) weather data: (([T0]+[T1]+[T2]+[T3])*133.8+([T4]+[T5]+[T6]+[T7])*315.8+([T8]+[T9]+[T10]+[T11])*443.9+([T12]+[T13]+[T14]+[T15])*540.6+([T16]+[T17]+[T18]+[T19])+636+( [T20]+[T21]+[T22]+[T23])+669.1+([T24]+[T25]+[T26]±[T27])*737.1+([T28]+[T29]+[T30]+[T31])*733.9+([T32]+[T33]+[T34]+[T35])*664.8+([T36]+[T37]+[T38]+[T39])*651.3+([T40]+[T41]+[T42]+[T43])*617.9+([T44]+[T45]+[T46]+[T47])*501.7+( [T48]+[T49]+[T50]±[T51])*336.6)/6982.5

The output of the solar analysis is a file that has the duration of shaded time for each for each solar point. An alternative method is to perform solar analysis for each points in the point cloud classified as roof or ground within the setback rules defined earlier.

In another embodiment, the solar analysis of this present invention has a workflow of calculating Surface Orientation Factor (SOF) of each roof plane. The inputs to calculate SOF are the roof tilt, azimuth, latitude and, longitude.

Solar panel layout algorithm as visualized in 508 has a work flow of panel layout and has as inputs set back polygons, roof obstruction polygons, solar points and roof SOF. Its output are 3D solar panel layout polygons and system specifications such as generation capacity in kilowatts, direct current data, and number of solar panels of specific dimensions. From a practical point of view, areas under a shade or having low SOF value or other screen criteria may not be desirable for solar panel placement, thus avoiding the need of processing and analyzing those areas all together. Another consideration in obstruction detection is the setback requirement. With this, obstructions along a roof ridge, thus along the boundaries of the image, needs not be considered.

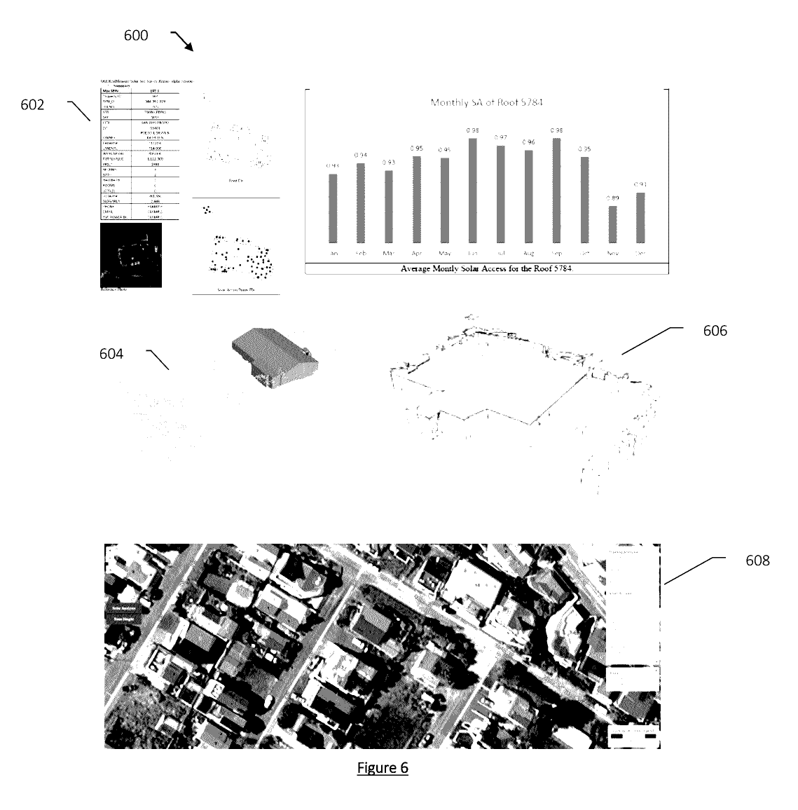

Directing attention to FIG. 6, there is shown example images, 600 of the solar data products generated by the solar analysis process of this present invention. The building and site dimensions, solar attributes, 2D and 3D drawings/models, solar panel layout, electrical generation estimate and financial parameters are combined in a report for each solar site. An example data report is shown in 602.

In another embodiment, a 3D site model including the point cloud of vegetation and terrain and 3D vectors and surface mesh of the building is exported in a user preferred format as shown in example 604.

In another embodiment, an alternative 3D site model including the average roof vector files with simplified roof obstructions is exported in a user preferred format as shown in example 606. The file size is smaller for this model as opposed to the model in 604 and the features (roof planes, facade, walls and roof obstructions) are produced by combining the extracted vectors from 300. This smaller size models with defined edges and roof planes are useful for downstream custom processing by the users using standard CAD applications using less computing resources. Both embodiments can be exported in formats including, but limited to, DWG, DXF, DAE, SKP, PRT, PLY, OBJ, KML, KMZ, STL or IGES.

In another embodiment, a geo-referenced site map with solar parameters is produced using this present invention as exemplified in 608. This map can be exported to common raster format such as, JPEG, TIFF or georeferenced map such as KMZ or PDF.

Directing attention to FIG. 7, there is shown a system architecture 700 as one of the embodiments to visualize the solar data products generated by this present invention. In this visualization system computer graphics and virtual reality technology are combined with GIS applications, web services and 3D modeling to dynamically display georeferenced solar design data. There are three layers in this data visualization system.

The interface layer, 702 enables users to operate the system for performing solar site survey and analysis as one of the embodiments of this present invention. The application layer, 704 which includes geomatics, image processing, solar analysis and CAD applications, provides

What is claimed is:

1. A method and system of surveying solar site, generating and distributing solar design, sales and marketing data, the method and system comprising:
Collecting of plurality of aerial images and sensor data for single or multiple solar installation site using a UAS platform, and generating solar design data with selections from the group consisting solar access, surface orientation factor, total solar access, identified setbacks, identified roof obstructions/penetrations, solar module/panel layout, illustrations, descriptions of electrical generation, site model, shade animation and financial analyses for solar generator configurations, wherein selections from the group are calculated from sources of data other than data gathered by a human manually assessing the individual real properties yet are specific to individual real properties; communicating portions of data contained in the database to users across a communication network; facilitating communication between users and this system over the communication network; and receiving at least one fee from at least one of the group consisting of users and consumers.

2. The method of claim 1, wherein calculating from sources of data comprises: reading images, points, lines and polygons that are associated with a planar area and an external set of variables; reading an external set of variables; generating at least one rule based on the external set of variables; applying the rule to individual point, line and/or polygon that were read; and updating the individual point, line and/or polygon based on the applied rule.

3. The method of claim 1, wherein solar access comprises sun duration for each access point calculated using sun position, georeferenced digital surface models, surface mesh, point cloud and building polygons as inputs using a combination of CPU and GPU processing of ray tracing and solar viewshed algorithms.

4. The method of claim 1, wherein roof obstructions are calculated by reading point cloud and imagery data associated with a real property, processing the data to produce polygons representing roof obstructions and combining the obstructions with roof planes and building walls into a 3D building model.

5. The method of claim 1, wherein multiple solar design data products generated for users.

6. One of the method of claim 1, wherein this system replaces the manual solar shade measurement handheld tools.

7. One of the method of claim 1, wherein multiple solar sites are surveyed and the solar products are generated for individual sites by separating them by property lines or demarking on the map.

8. A method of claim 1, wherein a video animation is created to visualize the dynamic shading over the solar site during a time period, visualizing selections of the group; 3D vectors of building, 3D vectors and polygons of roof obstructions, classified point cloud, surface mesh, property lines and solar analysis results.

9. The method of claim 2, wherein one of the external set of variables comprises a fire code.

10. The method of claim 2, wherein the at least one rule comprises a setback distance from an edge of a rooftop to a point on the rooftop.

11. The method of claim 2, wherein one of the external set of variables comprises a database of solar panel dimensions and output power rating.

12. The method of claim 3, wherein the solar viewshed algorithm comprises moving an observer entity in the path of the sun for time periods throughout the day and records if the line of sight to a point of interest from the sun is obstructed or visible.

13. One of such data products of claim 5, is a data report containing parcel data, aerial image, solar and building parameters of each roof plane, 2D roof drawings, solar point locations, solar access data and graphs, electrical generation and financial return on investment data and graphs.

14. One of the such data products of claim 5, is a 3D building model with average roof planes, defined walls, facade and roof obstructions.

15. One of the such data products of claim 5, is a georeferenced solar map which contains layers of aerial images, rooflines, obstructions, solar points, trees and solar analysis results.

16. One of the data products of claim 5, is a 3D site model including the trees, vegetations, terrain, structures, property lines and buildings with roofs and roof obstructions.

17. The method of claim 13, wherein each tree, exceeding a predefined height or diameter threshold is identified as a point with measured values of height and diameter.

18. The method of claim 14, wherein the 3D building model is produced in standard CAD file formats such as Sketch Up (SKP extension), AutoCAD (DWG/DXF extension), Solid Works (PRT extension), COLLADA (DAE extension) and Google Earth (KMZ/KML extension).
